(19) United States
(12) Patent Application Publication
(10) Pub. No.: US 2021/0056451 A1
(43) Pub. Date: Feb. 25, 2021

(54) OUTLIER PROCESSING IN TIME SERIES DATA

(71) Applicant: International Business Machines Corporation, Armonk, NY (US)

(72) Inventors: Si Er Han, XI'AN (CN); Song Bo, XI'AN (CN); Peng Fei Chang, XI'AN (CN); Jun Wang, XI'AN (CN)

(21) Appl. No.: 16/543,754

(22) Filed: Aug. 19, 2019

(51) Int. Cl. G06N 7/00; G06N 5/02

(52) U.S. Cl. CPC G06N 7/005; G06N 5/022

(57) ABSTRACT

This disclosure provides a solution for processing outliers in a time series. In the method, a time series model is obtained based on a first set of observed values. Outliers are identified from the first set of observed values based on the differences between the first set of observed values and a first set of predicted values. The first set of predicted values is obtained from the first set of observed values by using the time series model. A model evaluation measure representing differences between a second set of observed values and a second set of predicted values is calculated. The second set of predicted values is obtained from the second set of observed values by using the time series model. And replacement values for the outliers are determined in response to the model evaluation measure not meeting a predefined criterion.

### BACKGROUND

The present disclosure relates generally to data processing, and more specifically, to methods, systems and computer program products for processing outliers in time series data.

A “time series” is a sequence of data points taken at successive equally spaced points in time. “Time series forecasting” is the use of a model to predict future values based on previous observed values. Time series data have a natural temporal ordering. An outlier is a data point that differs significantly from other points. An outlier may be due to variability in the measurement or it may indicate experimental error. For example, Internet of Things (IoT) data are often collected by sensors. The sensors may collect unusually high or low values due to the sensors' limitations. For example, low battery, memory resource, computation bandwidth, or actual events such as a fire that can occur to affect the sensors' readings. Such unusually high or low values can significantly deviate from the previous readings. Without outlier handling, traditional data analysis may fail because outliers can distort the variance of other data in a data set. The outliers can also affect a predictive model used in the forecasting of future values.

### SUMMARY

According to embodiments of the present disclosure, a computer-implemented method for processing outliers in a time series is provided. The method includes a time series model based on a first set of observed values. The first set of observed values is a first part of a time series. One or more outliers are identified from the first set of observed values based on the differences between the first set of observed values and a first set of predicted values. The first set of predicted values is obtained from the first set of observed values by using the time series model. A model evaluation measurement, representing differences between a second set of observed values and a second set of predicted values, is calculated. The second set of observed values is a second part of the time series. The second set of predicted values is obtained from the second set of observed values using the time series model. One or more replacement values for the one or more outliers are determined in response to the model evaluation measurement not meeting a predefined criterion.

Other embodiments and aspects, including but not limited to, computer systems and computer program products, are described in detail herein and are considered a part of the claimed disclosure.

These and other features and advantages of the present disclosure will be described or will become apparent to those of ordinary skill in the art in view of, the following detailed description of the example embodiments of the present disclosure.

### BRIEF DESCRIPTION OF DRAWINGS

Through the more detailed description of some embodiments of the present disclosure and the accompanying drawings, the above and other objects, features and advantages of the present disclosure will become more apparent, wherein the same reference generally refers to the same components in the embodiments of the present disclosure.

FIG. 1 illustrates a flowchart of a method for processing outliers according to embodiments of the present disclosure.

FIG. 2 illustrates a flowchart of a method for optimizing outlier replacement values according to embodiments of the present disclosure.

FIG. 3A-3D illustrates an example of processing outliers according to embodiments of the present disclosure.

FIG. 4 is a high-level block diagram illustrating an example computer system that may be used in implementing one or more of the methods, tools, and modules, and any related functions, described herein, according to embodiments of the present disclosure.

FIG. 5 depicts a cloud computing environment according to embodiments of the present disclosure.

FIG. 6 depicts abstraction model layers according to embodiments of the present disclosure.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

Currently, there are methods that automatically detect outliers in a time series that reach or exceed a specified threshold. Once detected, the values of the outliers are replaced with estimated values. For example, a window may be established around a detected outlier. The window can cover the outlier as well as surrounding data points. A mean value, or an interpolation value, may be calculated using the values of the surrounding data points within the window. The mean value, or interpolation value, can then be used as a replacement value for the outlier.

However, some true outliers may be hidden in complicated time series patterns. A true outlier may indicate trend or seasonality, and automatic outlier detection methods, using a specified threshold, make it difficult to detect such outliers. Even when a true outlier is detected, a user may still need to specify a method and a size of window around the outlier. Based on the method and window, the user then has to build models and check the results. Typically, the process of establishing the window, building a model, and generating an output is manually repeated until a good model is determined. This repeated process can be laborious and time consuming for the user.

To handle outliers, embodiments of the present disclosure determine the replacement values for outliers efficiently. According to embodiments, data of a time series is split into training data and testing data. The surrounding data within a window, the training data, and the testing data are used in conjunction to handle the outliers. Specifically, the surrounding data are used to find initial replacement values for the outliers, the training data are used to build a time series model, and the testing data are used to optimize the replacement values of the outlier.

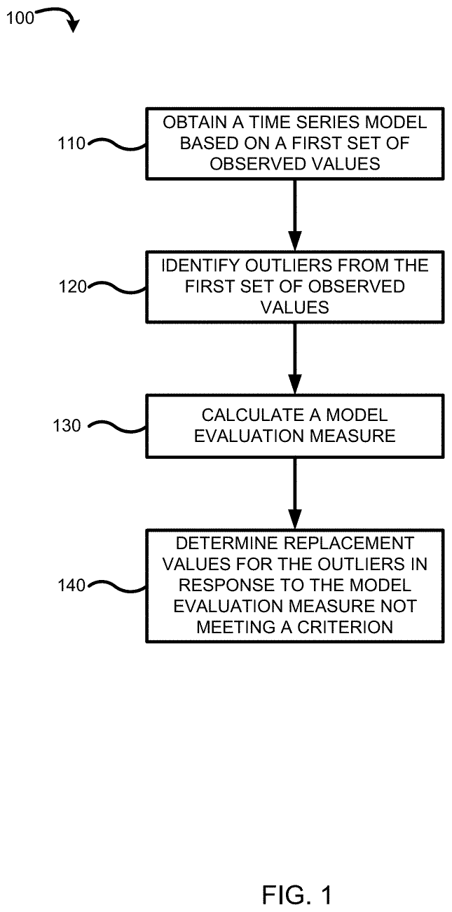

Reference is first made to FIG. 1, which illustrates a flowchart of a process 100 for handling outliers, according to embodiments of the present disclosure.

At operation 110, a time series model is obtained based on a first set of observed values. The first set of observed values is part of a time series, and may be considered as training data below.

The time series model may be any appropriate model using time series data. Models for time series data may have many forms and represent different stochastic processes. For example, time series models can be autoregressive (AR) models, integrated (I) models, and moving average (MA) models. An AR model is a representation of a type of random process which is used to describe certain time-varying processes in nature, economics, etc. An MA model, also known as a moving-average process, is a common approach for modeling univariate time series. The moving-average model specifies that the output variable depends linearly on the current and various past values of a stochastic (imperfectly predictable) term. Together with the AR model, the MA model is a special case and key component of the more general autoregressive moving average (ARMA) and autoregressive integrated moving average (ARIMA) models of time series, which can have a more complicated stochastic structure. According to embodiments, examples of the time series model include an ARIMA model or Exponential Smoothing (ES) model. It should be understood that the time series model may be built based on the time series values with any suitable and known model building method.

At operation 120, one or more outliers are identified from the first set of observed values. In statistics, an outlier is a data point that differs significantly from other observations. However, there is no rigid mathematical definition of what constitutes an outlier. Determining whether or not an observation is an outlier is ultimately a subjective exercise. As such, as described herein, an “outlier” is a value from the observed values predetermined as being a suspect value.

According to embodiments, outliers are identified based on the differences between the first set of observed values and a first set of predicted values. The first set of predicted values are obtained from the first set of observed values using the time series model. For example, for a specific time point, if the difference between the predicted value and the observed value is larger than a threshold, this specific time point with the observed value may be deemed as an outlier. Model-based outlier detection methods are commonly used for identification, which identify observations being deemed “unlikely” based on mean and standard deviation.

At operation 130, a model evaluation measurement is calculated. The model evaluation measurement represents the differences between a second set of observed values and a second set of predicted values. The second set of observed values belongs to the same time series data set with the first set of observed values and is later than the first set of observed values in temporal order. The second set of observed values can be used as testing data. The second set of predicted values are values predicted from the second set of observed values by using the time series model.

The model evaluation measurement may be any suitable measurement that represents the differences between the values predicted by a model, or estimator, and the values observed. For example, the model evaluation measurer may be a model accuracy measurement such as R squared, or a model error measurement such as a mean squared error. According to embodiments, the model evaluation measure is selected from one of the followings: Root Mean Square Error (RMSE), R Squared and Mean Absolute Error (MAE). For example, the RMSE is a frequently used measurement of the differences between the values predicted by a model and the values observed. The RMSE serves to aggregate the magnitudes of the errors in predictions at various times into a single measurement of predictive power. Thus, the model evaluation measurement of the testing data may reflect the quality of the time series model built based on the training data.

At operation 140, one or more replacement values, for the one or more identified outliers, are determined in response to the model evaluation measurement not meeting a predefined criterion. According to embodiments, the predefined criterion is a predefined threshold. The model evaluation measurement can be compared with the threshold. For example, if the error measurement is smaller than the threshold (i.e., meeting the predefined criterion), the first set of observed values is considered in good quality and replacement values to replace the outliers in the observed values are not needed. If the model evaluation measurement does not meet the predefined criterion, the replacement values are required to be determined.

According to embodiments, to determine initial replacement values for the outliers, a window around each of the outlier is determined. A replacement value for the outlier is calculated based on the values of the first set of observed values within the window.

According to embodiments, a window with an initial size is determined first. Using a predetermined time point on either side of the window, a difference between the predicted value and the observed value for the time point is calculated. If the absolute value of the difference is larger than a threshold, the time point will be added into the window. Thus, the size of the window is increased until no other time point on either side of the window meets the criterion. The threshold may be, for example, 3 times standard deviation of residuals of the whole time series or the training data. Therefore, the local data around the specific outliers are identified automatically. In some embodiments, the window size may be specified by a user manually.

According to embodiments, after the window has been determined, an initial replacement value for each of the outliers is estimated using, for example, mean, median or other statistics of the points within the corresponding window.

In time series data, seasonality is the presence of variations that occur at specific regular intervals less than a year. For example, weekly, monthly, or quarterly qualify as seasonal intervals. Seasonality may be caused by various factors, such as weather, vacation, and holidays and comprise of periodic, repetitive, and generally regular and predictable patterns in the levels of a time series. According to embodiments, if the data is non-seasonal, the replacement value is computed based on data within the window. However, if the data is seasonal, the replacement value is computed based on the data points within the window and data points in several of the same season that occur before or after the occurring season. In some embodiments, a standard deviation of the values of the data points used for estimating replacement values is calculated, and k times the standard deviation may be used to calculate an estimated range of the replacement values with a lower bound and an upper bound. The estimated range of the replacement values may be used to optimize the replacement values as further described with details below.

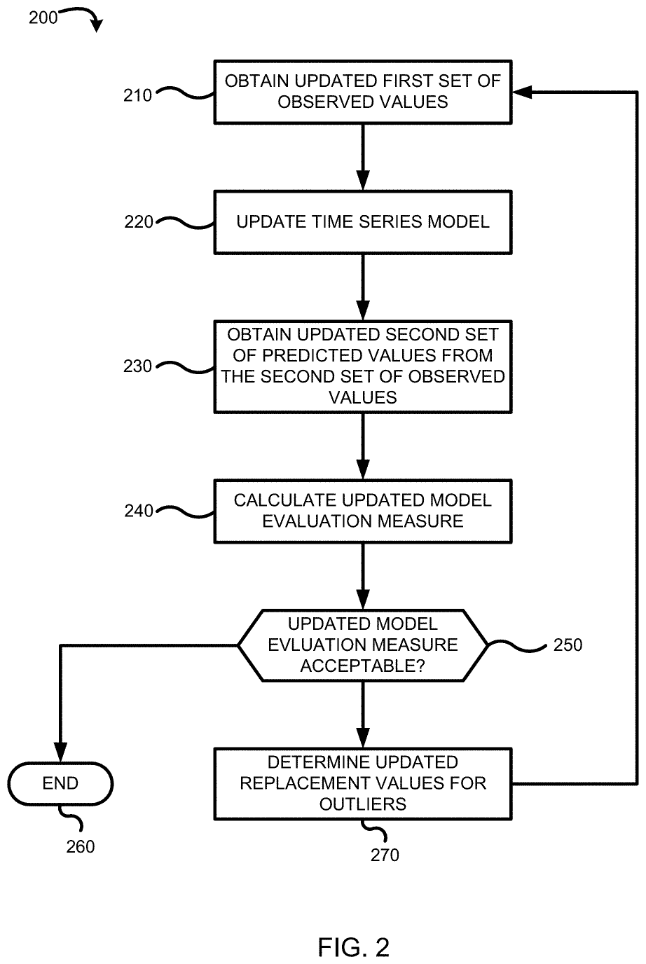

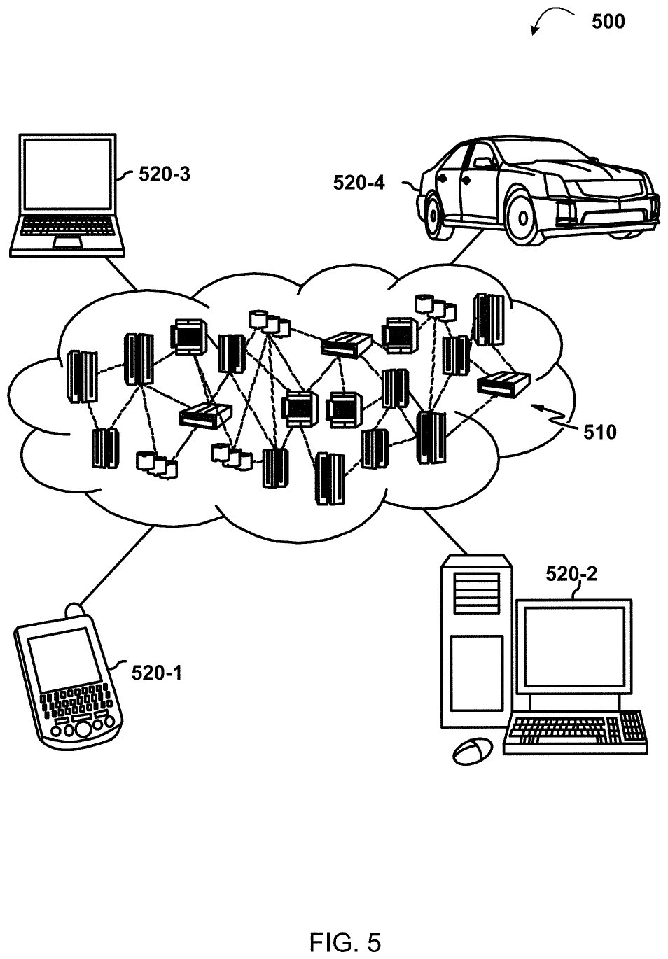

FIG. 2 illustrates a flowchart of a process 200 for optimizing outlier replacement values according to an embodiment of present disclosure. As shown in FIG. 5, the optimizing process may be an iterative process.

At operation 210, an updated first set of observed values is obtained using the one or more replacement values for the one or more outliers. The one or more replacement values may be the initial replacement values determined based on the first set of observed values, as described above with reference to operation 140. The one or more replacement values may also be replacement values determined in the previous iteration of the optimizing process.

At operation 220, an updated time series model is obtained based on the updated first set of observed values. As described above, the time series model may be built based on the time series values with any suitable and known model building method. A similar model building method may be used to update the time series model based on the updated first set of observed values.

At operation 230, an updated second set of predicted values is obtained from the second set of observed values by using the updated time series model.

At operation 240, an updated model evaluation measurement is calculated. The updated model evaluation measurement represents the difference between the second set of observed values and the updated second set of predicted values.

At operation 250, a determination is made whether the updated model evaluation measurement meets a predefined criterion. If the updated model evaluation measurement meets the predefined criterion, meaning the current replacement values for the outliers are acceptable, the process 200 proceeds to operation 260 and ends. If not, the process proceeds to operation 270, one or more updated replacement values for the outliers are determined. The process 200 returns to operation 210 where the one or more outliers in the first set of observed values are replaced with the updated replacement values and an updated first set of observed values are obtained. Operations 510 to 570 are repeated until the current replacement values for the outliers are acceptable at operation 550.

According to embodiments, the predefined criterion is that the model evaluation measure is larger, or smaller, than a specified threshold, depending on the type of evaluation measurement model. In some embodiments, the model evaluation measurement is an objective function of values for the one or more outliers, and the predefined criterion include the objective function reaching an extremum.

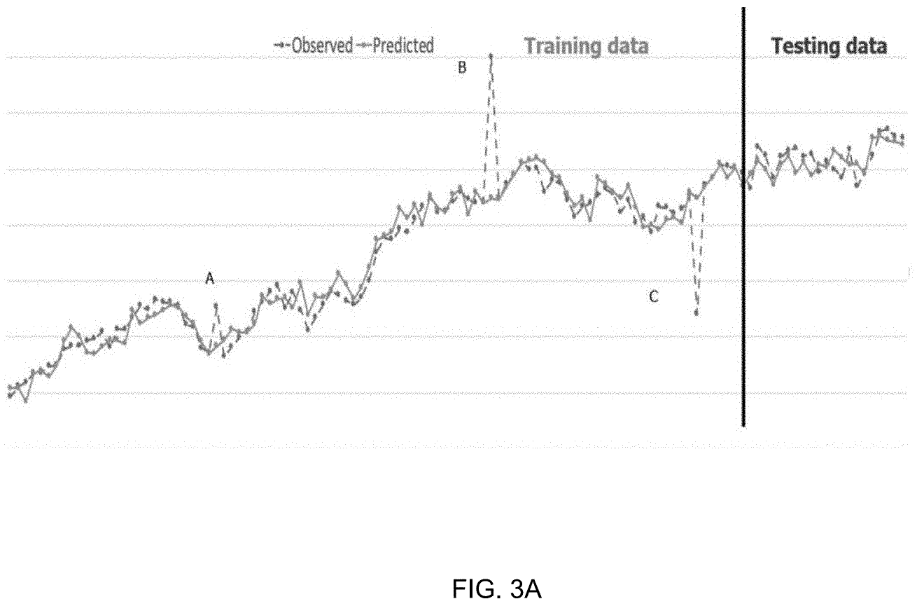

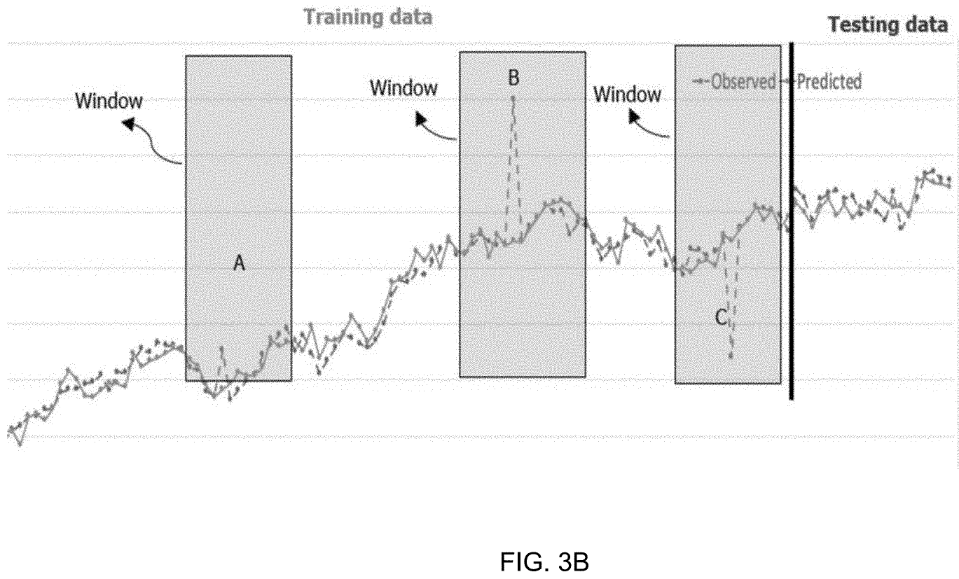

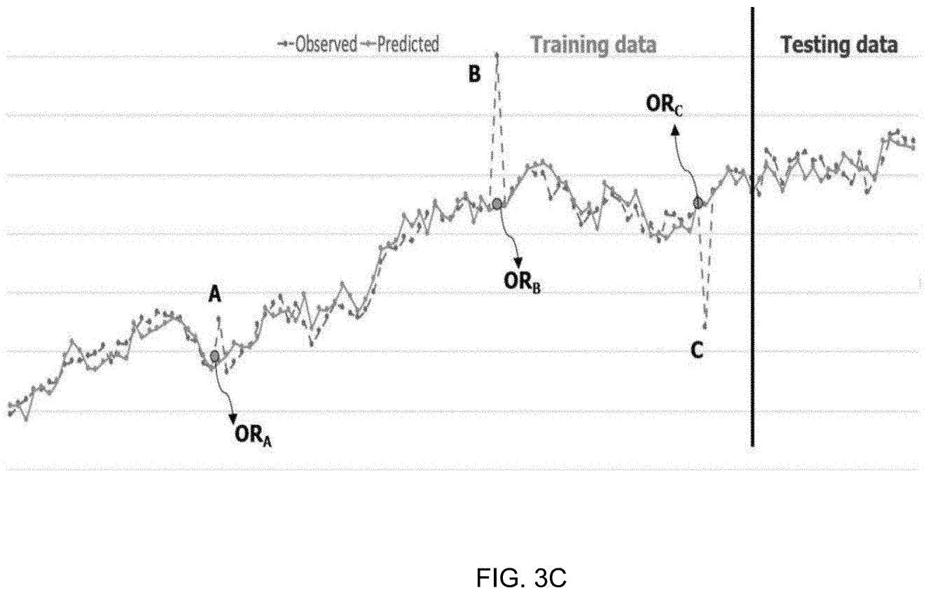

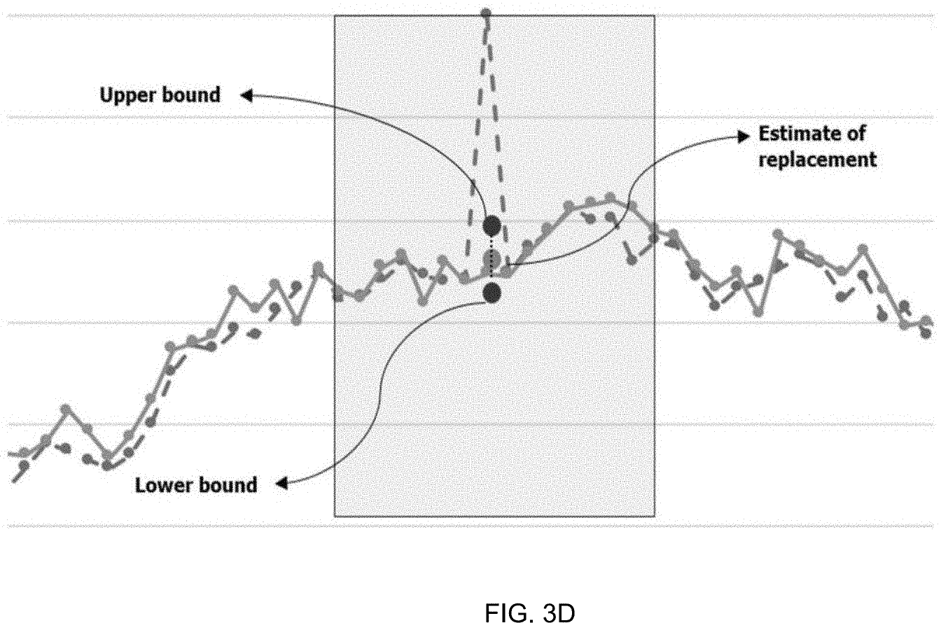

An exemplary execution of the disclosure is described with reference to FIGS. 3A-3D to illustrate the embodiments of the present disclosure. In this example, a data set having a plurality of time series values is received and split into a first set of observed values (training data) and a second set of observed values (testing data), as shown in FIG. 3A. The training data is used to build a time series model. And the testing data is used to evaluate the built time series model. A set of predicted values of the testing data may be obtained with the time series model based on the testing data. a model evaluation measurement may be computed based on the predicted values of the testing data and the observed values of the testing data. If the model evaluation measurement is unacceptable, that is, not meeting a predefined criterion, some outliers may be identified. The outliers are selected based on there being a large difference between the predicted values of the training data and the observed values of the training data. In the example as shown in FIG. 3A, the points A, B and C are selected as the outliers.

As shown in FIG. 3B, a window is determined for outliers A, B, and C. The size of the windows can be determined automatically based on the local data around each of the outliers. A replacement value for each outlier can be estimated in the corresponding window using mean, median, or other statistics, as shown in FIG. 3C. At the same time, a range of the replacement values can be estimated by the k times standard deviation of the differences between the observing values and the predicted values of the training data within each of the respective windows for the outliers. The range of the replacement values may be limited by an upper bound and a lower bound, as shown in FIG. 3D. In this example, the replacement values for outlier A, B and C are represented as OR_{A}, OR_{B}, and OR_{C}, respectively. The replacement values OR_{A}, OR_{B}, and OR_{C} are used to replace the original values for outliers A, B and C, and an updated training data set is obtained. The time series model is updated with the updated training data. With the updated time series model, the model evaluation measurement for the testing data can be calculated again.

The replacement values for the outliers can be optimized if the model evaluation measure is unacceptable. According to embodiments, the model evaluation measurement on testing data may be denoted as E(OR1, OR2, OR3, . . . ) which can be a model accuracy measurement such as R squared, or a model error measurement such as mean squared error, where ORi is the ith outlier value. The E(OR1, OR2, OR3, . . . ) may be represented as an objective function. As well known, the objective function is an equation to be optimized, given certain constraints, to be minimized or maximized using nonlinear programming techniques. The objective function can be a result of an attempt to express a business goal in mathematical terms for use in decision analysis, operations research, or optimization studies. In this example, the replacement values for the outliers are optimized such that the objective function can reach its maximum (e.g., for the model accuracy measure) or minimum (e.g., for the model error measure) depending on the specific type of model evaluation measurement being used. The constraint condition is that respective replacement values should be chosen within their estimated ranges, that is, within respective upper bounds and respective lower bounds. The objective function on testing data may be used to adjust outlier replacement values, which allows the model to capture recent patterns in time series data accurately, which can lead to accurate forecast results.

The optimization can be an iterative process. For example, for the ith iteration, where i is a variable integer representing any number of possible iterations, the updated replacement values for the outliers determined in (i−1)th iteration can be used as the replacement values to update the training data, thereby update the time series model, and then the objective function E(OR_{Ai}, OR_{Bi}, OR_{Ci}) and increments dA, dB and dC of replacement values for outliers A, B and C can be calculated. The updated replacement values for the outliers can be determined by adding respective increments dA, dB and dC to the replacement values in the ith iteration. Also, in the (i+1)th iteration, the updated replacement values for the outliers determined in ith iteration can be used as the replacement values and then similar operations can be performed as in the previous iteration. This iterative process can be repeated until the objective function reach its extremum (maximum or minimum). There are many known mathematical methods to solve the objective function E(OR_{Ai}, OR_{Bi}, OR_{Ci}) and calculate the increments dA, dB and dC to make the objective function E(OR_{Ai}, OR_{Bi}, OR_{Ci}) reaching a maximum or a minimum and the details would be omitted hereinwith.

Please note the example as shown in FIGS. 3A-3D is for just for illustrative purpose and should not limit the scope of the embodiments of the present disclosures.

With the methods as described according to embodiments of the present disclosure, the replacement values for the outliers in the observed values could be determined and optimized.

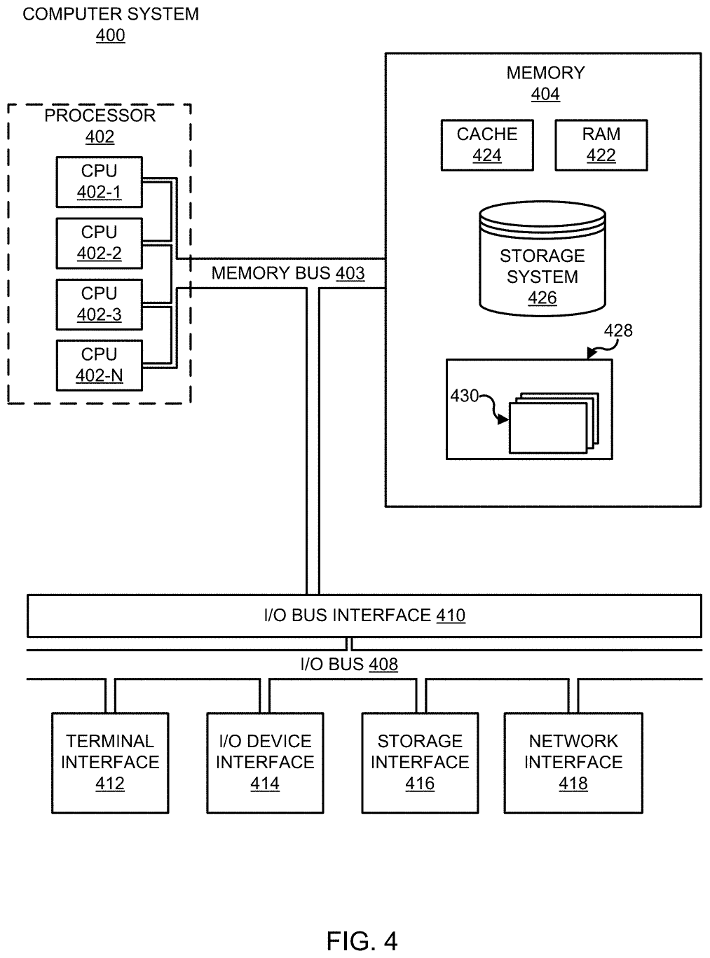

Referring now to FIG. 4, shown is a high-level block diagram of an example computer system 400 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 400 may comprise one or more processors 402, a memory 404, a terminal interface 412, a I/O (Input/Output) device interface 414, a storage interface 416, and a network interface 418, all of which may be communicatively coupled, directly or indirectly, for inter-component communication via a memory bus 403, a I/O bus 408, and an I/O bus interface 410.

The computer system 400 may contain one or more general-purpose programmable central processing units (CPUs) 402-1, 402-2, 402-3, and 402-N, herein generically referred to as the processor 402. In some embodiments, the computer system 400 may contain multiple processors typical of a relatively large system; however, in other embodiments the computer system 400 may alternatively be a single CPU system. Each processor 402 may execute instructions stored in the memory 404 and may include one or more levels of on-board cache.

The memory 404 may include computer system readable media in the form of volatile memory, such as random-access memory (RAM) 422 or cache memory 424. Computer system 400 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, the memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

Although the memory bus 403 is shown in FIG. 4 as a single bus structure providing a direct communication path among the processors 402, the memory 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 400 may, in some embodiments, contain multiple I/O bus interface units, multiple I/O buses, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 400 may be a multi-user mainframe computer system, a single-user system, or a server computer or similar device that has little or no direct user interface but receives requests from other computer systems (clients). Further, in some embodiments, the computer system 400 may be implemented as a desktop computer, portable computer, laptop or notebook computer, tablet computer, pocket computer, telephone, smart phone, network switches or routers, or any other appropriate type of electronic device.

It is noted that FIG. 4 is intended to depict the representative major components of an exemplary computer system 400. In some embodiments, however, individual components may have greater or lesser complexity than as represented in FIG. 4, components other than or in addition to those shown in FIG. 4 may be present, and the number, type, and configuration of such components may vary.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

It should be noted that the processing of handling outliers (or achieved by system for handling outliers) according to embodiments of this disclosure could be implemented by computer system 400 of FIG. 4.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 500 is depicted. As shown, cloud computing environment 500 includes one or more cloud computing nodes 510 with which local computing devices used by cloud consumers, such as, for example, personal digital assistant (PDA) or cellular telephone 520-1, desktop computer 520-2, laptop computer 520-3, and/or automobile computer system 520-4 may communicate. Nodes 510 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 520-1-4 shown in FIG. 5 are intended to be illustrative only and that computing nodes 510 and cloud computing environment 500 can communicate with any type of computerized device over any type of network and/or network addressable connection (e.g., using a web browser).

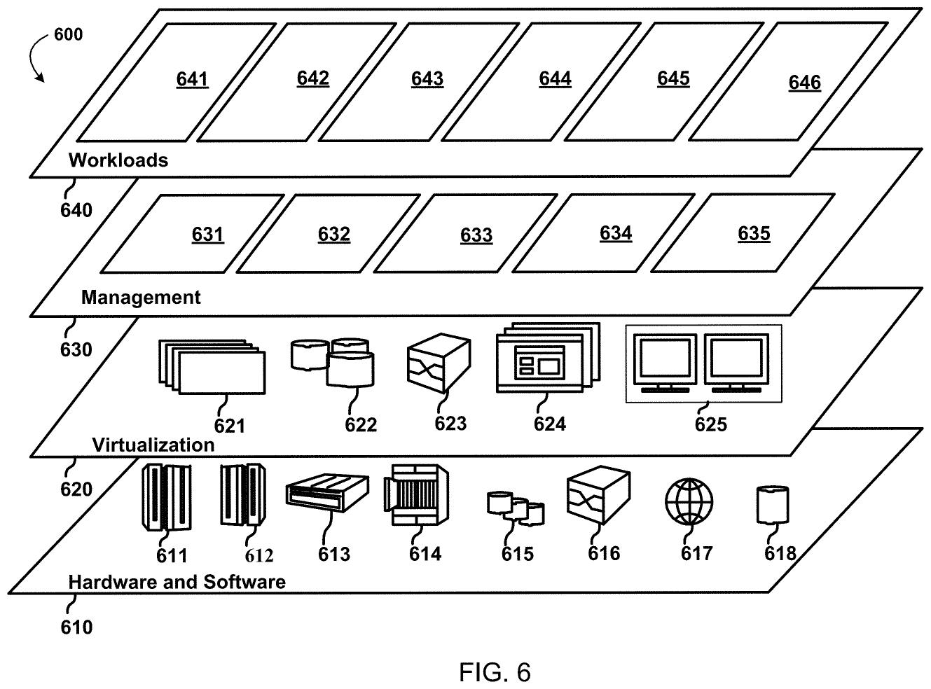

Referring now to FIG. 6, a set of functional abstraction layers provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 610 include hardware and software components. Examples of hardware components include: mainframes 611; RISC (Reduced Instruction Set Computer) architecture based servers 612; servers 613; blade servers 614; storage devices 615; and networks and networking components 616. In some embodiments, software components include network application server software 167 and database software 618.

Virtualization layer 620 provides an abstraction layer from which the following examples of virtual entities may be provided: virtual servers 621; virtual storage 622; virtual networks 623, including virtual private networks; virtual applications and operating systems 624; and virtual clients 625.

In one example, management layer 630 may provide the functions described below. Resource provisioning 631 provides dynamic procurement of computing resources and other resources that are utilized to perform tasks within the cloud computing environment. Metering and Pricing 632 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 633 provides access to the cloud computing environment for consumers and system administrators. Service level management 634 provides cloud computing resource allocation and management such that required service levels are met. Service Level Agreement (SLA) planning and fulfillment 635 provide pre-arrangement for, and procurement of, cloud computing resources for which a future requirement is anticipated in accordance with an SLA.

Workloads layer 640 provides examples of functionality for which the cloud computing environment may be utilized. Examples of workloads and functions which may be provided from this layer include: mapping and navigation 641; software development and lifecycle management 642; virtual classroom education delivery 643; data analytics processing 644; transaction processing 645; and efficient outlier determination 646.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

According to an embodiment of the present disclosure, there is provided a system, which may comprise one or more processors and a memory coupled to at least one of the one or more processors. The system may further comprise a set of computer program instructions stored in the memory and executed by at least one of the one or more processors in order to perform actions of obtaining a time series model based on a first set of observed values, the first set of observed values being a first part of a time series; identifying one or more outliers from the first set of observed values based on the differences between the first set of observed values and a first set of predicted values, the first set of predicted values being obtained from the first set of observed values by using the time series model; and determining one or more replacement values for the one or more outliers based on a model evaluation measure, the model evaluation measure representing the differences between a second set of observed values and a second set of predicted values, wherein the second set of observed values is a second part of the time series, and the second set of predicted values is obtained from the second set of observed values by using the time series model.

According to an embodiment of the present disclosure, there is provided a computer program product. The computer program product may comprise a computer readable storage medium having program instructions embodied therewith. The program instructions may be executable by a device to perform a method. The method may comprise: obtaining a time series model based on a first set of observed values, the first set of observed values being a first part of a time series; identifying one or more outliers from the first set of observed values based on the differences between the first set of observed values and a first set of predicted values, the first set of predicted values being obtained from the first set of observed values by using the time series model; and determining one or more replacement values for the one or more outliers based on a model evaluation measure, the model evaluation measure representing the differences between a second set of observed values and a second set of predicted values, wherein the second set of observed values is a second part of the time series, and the second set of predicted values is obtained from the second set of observed values by using the time series model.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
obtaining, by one or more processing units, a time series model based on a first set of observed values, wherein the first set of observed values includes a first part of a time series;
identifying, by the one or more processing units, one or more outliers from the first set of observed values based on the first set of observed values and a first set of predicted values, wherein the first set of predicted values is obtained from the first set of observed values using the time series model;
calculating, by the one or more processing units, a model evaluation measurement representing differences between a second set of observed values and a second set of predicted values, wherein the second set of observed values is a second part of the time series, and the second set of predicted values is obtained from the second set of observed values using the time series model; and
determining, by the one or more processing units, one or more replacement values for the one or more outliers in response to the model evaluation measurement not meeting a predefined criterion.

2. The computer-implemented method of claim 1, further comprising:
obtaining, by the one or more processing units, an updated first set of observed values by using the one or more replacement values for the one or more outliers;
obtaining, by the one or more processing units, an updated time series model based on the updated first set of observed values;
obtaining, by the one or more processing units, an updated second set of predicted values from the second set of observed values using the updated time series model;
calculating, by the one or more processing units, an updated model evaluation measurement representing the differences between the second set of observed values and the updated second set of predicted values; and
determining, by the one or more processing units, one or more updated replacement values for the one or more outliers in response to the updated model evaluation measurement not meeting the predefined criterion.

3. The computer-implemented method of claim 2, further comprising:
repeating, by the one or more processing units, steps to optimize the updated model evaluation measurement using the one or more updated replacement values as the one or more replacement values.

4. The computer-implemented method of claim 1, wherein the model evaluation measure is an objective function of values for the one or more outliers, and wherein the predefined criterion includes the objective function reaching an extremum.

5. The computer-implemented method of claim 1, wherein the determining one or more replacement values for the one or more outliers in response to the model evaluation measure not meeting the predefined criterion includes:
for each outlier of the identified one or more outliers,
determining, by the one or more processing units, a window around the outlier; and
calculating, by the one or more processing units, a replacement value for the outlier using the first set of observed values within the window.

6. The computer-implemented method of claim 1, wherein the second set of observed values is later than the first set of observed values in temporal order.

7. The computer-implemented method of claim 1, wherein the model evaluation measurement is a root mean square error.

8. A computer system comprising:
one or more processors;
a memory coupled to at least one of the one or more processors;
a set of computer program instructions stored in the memory and executed by at least one of the one or more processors in order to perform actions of:
obtaining a time series model based on a first set of observed values, wherein the first set of observed values is a first part of a time series;
identifying one or more outliers from the first set of observed values based on differences between the first set of observed values and a first set of predicted values, wherein the first set of predicted values is obtained from the first set of observed values using the time series model;
calculating a model evaluation measurement representing differences between a second set of observed values and a second set of predicted values, wherein the second set of observed values is a second part of the time series, and the second set of predicted values is obtained from the second set of observed values using the time series model; and
determining one or more replacement values for the one or more outliers in response to the model evaluation measurement not meeting a predefined criterion.

9. The computer system of claim 8, wherein the actions further comprise:
obtaining an updated first set of observed values using the one or more replacement values for the one or more outliers;
obtaining an updated time series model based on the updated first set of observed values;
obtaining an updated second set of predicted values from the second set of observed values using the updated time series model;
calculating an updated model evaluation measurement representing the differences between the second set of observed values and the updated second set of predicted values; and
determining, one or more updated replacement values for the one or more outliers in response to the updated model evaluation measurement not meeting the predefined criterion.

10. The computer system of claim 9, wherein the actions further comprise: repeating steps to optimize the updated model evaluation measurement using the one or more updated replacement values as the one or more replacement values.

11. The computer system of claim 8, wherein the model evaluation measurement is an objective function of values for the one or more outliers, and the predefined criterion includes the objective function reaching an extremum.

12. The computer system of claim 8, wherein the determining one or more replacement values for the one or more outliers in response to the model evaluation measure not meeting the predefined criterion includes:
for each outlier of the identified one or more outliers,
determining a window around the outlier; and
calculating a replacement value for the outlier using the first set of observed values within the window.

13. The computer system of claim 8, wherein the second set of observed values is later than the first set of observed values in temporal order.

14. The computer system of claim 8, wherein the model evaluation measure is a root mean square error.

15. A computer program product comprising a computer readable storage medium having program instructions embodied therewith, the program instructions being executable by a device to perform a method comprising:
obtaining a time series model based on a first set of observed values, wherein the first set of observed values is a first part of a time series;
identifying one or more outliers from the first set of observed values based on differences between the first set of observed values and a first set of predicted values, wherein the first set of predicted values is obtained from the first set of observed values using the time series model;
calculating a model evaluation measurement representing differences between a second set of observed values and a second set of predicted values, wherein the second set of observed values is a second part of the time series, and the second set of predicted values is obtained from the second set of observed values using the time series model; and
determining one or more replacement values for the one or more outliers in response to the model evaluation measurement not meeting a predefined criterion.

16. The computer program product of claim 15, wherein the method further comprises:
obtaining an updated first set of observed values using the one or more replacement values for the one or more outliers;
obtaining an updated time series model based on the updated first set of observed values;
obtaining an updated second set of predicted values from the second set of observed values using the updated time series model;
calculating an updated model evaluation measurement representing the differences between the second set of observed values and the updated second set of predicted values; and
determining, one or more updated replacement values for the one or more outliers in response to the updated model evaluation measurement not meeting the predefined criterion.

17. The computer program product of claim 16, wherein the method further comprises: repeating steps to optimize the updated model evaluation measurement using the one or more updated replacement values as the one or more replacement values.

18. The computer program product of claim 15, wherein the model evaluation measurement is an objective function of values for the one or more outliers, and the predefined criterion includes the objective function reaching an extremum.

19. The computer program product of claim 15, wherein the determining one or more replacement values for the one or more outliers in response to the model evaluation measure not meeting the predefined criterion includes:
for each outlier of the identified one or more outliers,
determining a window around the outlier; and
calculating a replacement value for the outlier using the first set of observed values within the window.

20. The computer program product of claim 15, wherein the second set of observed values is later than the first set of observed values in temporal order.
